(19) United States
(12) Patent Application Publication
(10) Pub. No.: US 2024/0370012 A1
(43) Pub. Date: Nov. 7, 2024

(54) QUALITY CAUSE ANALYSIS SYSTEM

(71) Applicants: National Chengchi University, Taipei City (TW); Dinkle Enterprise Co., Ltd, New Taipei City (TW)

(72) Inventors: FANG YU, Taipei City (TW); MING-SHIOW LO, Taipei City (TW)

(21) Appl. No.: 18/653,200

(22) Filed: May 2, 2024

(30) Foreign Application Priority Data
May 2, 2023 (TW) 112116292

(51) Int. Cl. G05B 23/02

(52) U.S. Cl. CPC G05B 23/0294; G05B 23/024

(57) ABSTRACT

A quality cause analysis system is disclosed, including an input device, a storage device, a processing device and an output device. The storage device stores machine status data, product measurement data, and a plurality of algorithms. The processing device accesses the storage device to establish a quality cause analysis model. The quality cause analysis model includes a quality prediction module, a network explanation module and an optimal machine prediction module. The quality prediction module predicts whether the product measurement data meets the quality inspection regulations. The network explanation module uses an explainable AI algorithm to measure the Shapley value of the state variables. The optimal machine prediction module calculates the capability of accuracy value and selects a plurality of machine status data closest to the standard center value as the optimal machine data.

### CROSS-REFERENCE TO RELATED APPLICATION

This application claims priority from Taiwan Patent Application No. 112116292, filed on May 2, 2023, in the Taiwan Intellectual Property Office, the content of which is hereby incorporated by reference in its entirety for all purposes.

### BACKGROUND OF THE INVENTION

### 1. Field of the Invention

The present disclosure relates to a quality cause analysis system, particularly to a quality cause analysis system able to obtain the optimal contribution level and the optimal parameters of the machine through an explainable AI method combined with the optimal machine evaluation and Taguchi method.

### 2. Description of the Related Art

The global manufacturing industry is rapidly developing towards big data and intelligence, and the intelligent transformation of the manufacturing industry has a great impact on the competitiveness of the industry. The existing manufacturing industry can effectively enhance its productivity through automated equipment for manufacturing; however, it is not possible to have the real-time quality status in control, not to mention reducing the labor cost and time consumed by quality control. After the entire batch has been manufactured, a sampling inspection is done to confirm whether there are any defects or defective products. As a result, not only is it easy to incur the cost of defective products in the whole batch, but also the quality level of the overall product may be reduced.

In the process of intelligent transformation, the introduction of artificial intelligence technology to assist enterprises in process reengineering is the main direction of efforts to enhance the competitiveness of enterprise production. For the whole process of production and machine, if the status of the machine and the product can be monitored in the production process and an early warning of product defects can be provided before the occurrence of defects, the cost of waste can be effectively reduced in the workflow, and adjustments are made to the processes and machines where problems occur to effectively optimize the production process and achieve better results in the production of final products and the quality control thereof.

In this view, the existing quality inspection methods make it difficult to ensure real-time monitoring of quality during the production process and to analyze the causes of quality defects. In this regard, the inventor of the present disclosure has designed a quality cause analysis system to tackle deficiencies in the prior art and further enhance the implementation and application in industries.

### SUMMARY OF THE INVENTION

Given the aforementioned conventional technical problems, the purpose of the present disclosure is to provide a quality cause analysis system to solve the difficulties of detecting product specification defects in real time, analyzing the cause of defects, and making immediate adjustments by traditional quality inspection.

According to one purpose of the present disclosure, a quality cause analysis system is provided, including an input device, a storage device, a processing device and an output device. The input device is connected to a production machine and a measuring machine and receives machine status data from the production machine and product measurement data from the measuring machine. The storage device is connected to the input device, and the storage device stores the machine status data, the product measurement data, and a plurality of algorithms. The processing device is connected to the storage device, the processing device executes a plurality of control commands to access the storage device to establish a quality cause analysis model, and the quality cause analysis model includes a quality prediction module, a network explanation module, and an optimal machine prediction module. The quality prediction module inputs the machine status data and the product measurement data into a real-time quality prediction network and predicts whether the product measurement data meets quality inspection regulations by the machine status data. The network explanation module performs an approximate calculation of the real-time quality prediction network by an explainable AI algorithm to measure a Shapley value of a plurality of state variables in the machine status data to the product measurement data. The optimal machine prediction module calculates a capability of accuracy value (CK value) of the machine status data corresponding to the product measurement data and selects a plurality of machine status data whose capability of accuracy value is closest to a standard center value as optimal machine data. The output device is connected to the processing device and the storage device and outputs the Shapley value of the plurality of state variables and the optimal machine data for an analysis of quality causes of produced products.

Preferably, the production machine may include a stamping machine and the measuring machine includes a transient detector.

Preferably, the real-time machine status data may include dataset numbering, machine rotation speed, machine status and number of stamping per second.

Preferably, the product specification measurement data may include dataset numbering, inspection time and specification measurement value.

Preferably, the capability of accuracy value may include a maximum specification evaluation value and a minimum specification evaluation value of a predicted product specification; if the maximum specification evaluation value is greater than an upper tolerance bound, the predicted product specification is adjusted based on the maximum specification evaluation value, and if the minimum specification evaluation value is less than a lower tolerance bound, the predicted product specification is adjusted based on the minimum specification evaluation value.

Preferably, the quality cause analysis model may further include a recommended machine data module, which performs a weighted calculation on machine data of a default period number among the optimal machine data through the Shapley value, calculates correlation coefficient together with actual machine data respectively, and selects data with the correlation coefficient closest to 1 as recommended machine data.

Preferably, the weighted calculation may be to add a current period Shapley value to the machine data, and the current period Shapley value is an absolute value of the maximum specification evaluation value and an absolute value of the minimum specification evaluation value.

Preferably, the quality cause analysis model may further include a Taguchi method analysis module, which calculates a system parameter in the real-time quality prediction network and obtains optimal parameter combination through system parameter optimization.

Preferably, the system parameter may include a signal-to-noise ratio (SN).

Preferably, the signal-to-noise ratio may be calculated by multiplying every period of machine data and every period of Shapley values and summing them up, a result of which is divided into two groups that are within a standard deviation or outside the standard deviation, as well as calculating a specification value of parameter combination through orthogonal table permutations, which is then substituted to a Nominal-The-Best (NTB) method to obtain the signal-to-noise ratio.

As mentioned above, the quality cause analysis system of the present disclosure may have one or more following advantages:

(1) This quality cause analysis system may predict product specifications according to the real-time machine status data of production machines by establishing a quality prediction model, so that the production status of the product may be monitored in real-time during the production process. When the product specifications exceed the set rules, an immediate warning will be issued to adjust the machines in production to avoid scrapping the entire batch of defective products and increasing production costs.

(2) The quality cause analysis system may determine the degree to which various parameters in the machine status affect quality by combining the explainable AI calculation method and further obtain the optimal machine data through the analysis of the contribution level of various parameters, allowing operators to improve quality control by adjusting or correcting machine parameters.

(3) This quality cause analysis system may obtain the optimal parameter combinations through the Taguchi method and optimize the machining process through the data in these combinations, thus enhancing overall productive efficiency, reducing time and cost for process optimization, and improving the competitiveness of R&D and production of enterprises.

### BRIEF DESCRIPTION OF THE DRAWINGS

To make the technical features, content, and advantages of the present disclosure and the achievable effects more obvious, the present disclosure is described in detail together with the drawings and in the form of expressions of the embodiments as follows:

FIG. 1 is a block diagram of the quality cause analysis system according to an embodiment of the present disclosure.

FIG. 2 is a schematic diagram of machine status data and product measurement data according to an embodiment of the present disclosure.

FIG. 3 is a systematic architectural diagram of the quality prediction model according to an embodiment of the present disclosure.

FIG. 4 is a schematic diagram of the network explanation module according to an embodiment of the present disclosure.

FIG. 5 is an operational flowchart of a recommended machine data module according to an embodiment of the present disclosure.

FIG. 6 is an operational flowchart of the Taguchi method according to an embodiment of the present disclosure.

### DESCRIPTION OF THE PREFERRED EMBODIMENTS

To illustrate the technical features, contents, advantages and achievable effects of the present disclosure, the embodiments together with the accompanying drawings are described in detail as follows. However, the drawings are used only to indicate and support the specification, which is not necessarily the real proportion and precise configuration after the implementation of the present disclosure. Therefore, the relations of the proportion and configuration of the accompanying drawings should not be interpreted to limit the actual scope of implementation of the present disclosure.

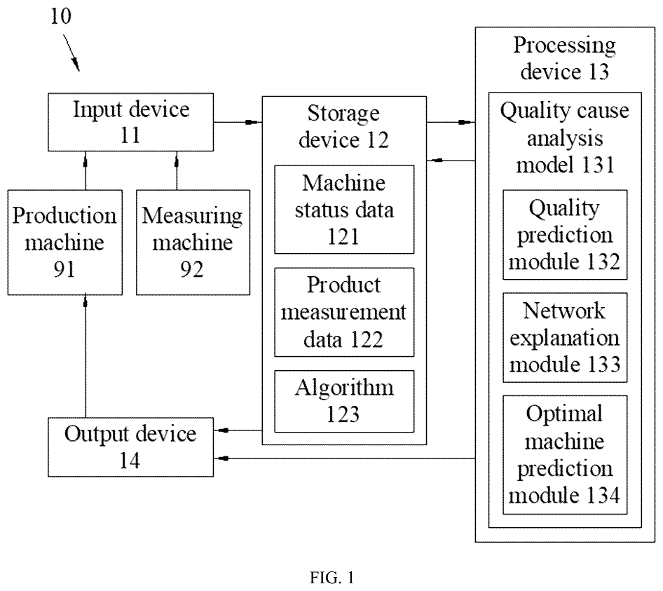

Please refer to FIG. 1, which is a block diagram of the quality cause analysis system according to an embodiment of the present disclosure. As shown in the figure, the quality cause analysis system 10 includes an input device 11, a storage device 12, a processing device 13 and an output device 14. The input device 11 is connected to a production machine 91 and a measuring machine 92. Machine status data 121 of the production machine 91 and product measurement data 122 of the measuring machine 92 are transmitted to the storage device 12 through the input device 11. The input device 11 may be a data collector, which is installed on the production machine 91 and the measuring machine 92 to monitor the production status of the production machine 91 and the detection status of the measuring machine 92. In other embodiments, the input device 11 may be a data transmission interface connected to the production machine 91 and the measuring machine 92, and the detection data of the machine is transmitted to the storage device 12 through the data transmission interface.

The storage device 12 is connected to the input device 11 and stores machine status data 121, product measurement data 122 and a plurality of algorithms 123. The storage device 12 may be storage media such as a read-only memory, a flash memory, a disk, or a cloud database of a computer device, or may be a server or a database of a cloud device. When the machine status data 121 and product measurement data 122 are received from the input device 11, these data may be stored in the storage device 12 for follow-up analysis, and various analytic algorithm programs are also stored in the storage device 12. The processing device 13 is connected to the storage device 12, and the processing device 13 includes a central processing unit, a microprocessor, an image computing processor, etc., in a computer or server device. The processing device 13 may execute control commands to access data in the storage device 12 and establish a quality cause analysis model 131 by executing algorithms and analytic programs.

The quality cause analysis model 131 includes a quality prediction module 132, a network explanation module 133 and an optimal machine prediction module 134. The quality prediction module 132 inputs the machine status data 121 and the product measurement data 122 into a real-time quality prediction network and predicts whether the product measurement data 122 meets quality inspection regulations by the machine status data 121. The network explanation module 133 performs an approximate calculation of the real-time quality prediction network by an explainable AI algorithm to measure a Shapley value of a plurality of state variables in the machine status data 121 to the product measurement data 122. The optimal machine prediction module 134 calculates a capability of accuracy value of the machine status data corresponding to the product measurement data and selects a plurality of machine status data whose capability of accuracy value is closest to a standard center value as optimal machine data. The output device 14 is connected to the processing device 13 and the storage device 12 and outputs the Shapley value of the plurality of state variables and the optimal machine data for an analysis of quality causes of produced products.

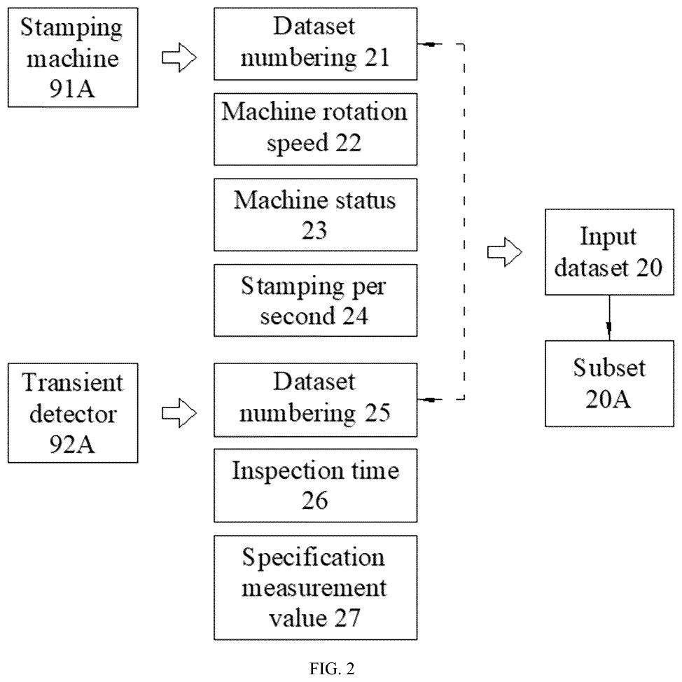

Please refer to FIG. 2, which is a schematic diagram of machine status data and product measurement data according to an embodiment of the present disclosure. As shown in the previous embodiment, the machine status data 121 and product measurement data 122 of the production machine 91 and the measuring machine 92 respectively represent the production status of the production machine 91 and the relevant specifications of the final product inspected by the measuring machine 92. The conventional quality management, which is considered inefficient, mainly involves having the specifications of final products inspected by machines or workers after the machines finish the entire batch of products. When the defective rate is high, several final products would be eliminated, causing a lot of cost losses. If product quality can be monitored in real-time during the production process, predictions may be made and production line personnel may be reminded to make corrections before defective products occur. Not only may the waste of scrap products be reduced, but also production quality and yield may be improved effectively. As shown in the figure, the stamping machine 91A is taken as an example for the production machine 91, while the transient detector 92A is taken as an example for the measuring machine 92 to replace the manual inspection method. By monitoring the data of the stamping machine 91A and the transient detector 92A in real-time, real-time quality prediction is performed to achieve the effect of real-time monitoring and management.

In the present embodiment, the machine status data 121 of the stamping machine 91A includes dataset numbering 21, machine rotation speed 22, machine status 23 and number of stamping per second 24. The product measurement data 122 of the transient detector 92A includes dataset numbering 25, inspection time 26 and specification measurement value 27. The dataset numbering 21 of the machine status data 121 includes stamping time (inspection of setup time of work order), machine numbering and work order numbering of the stamping machine 91A. The dataset numbering 25 of the corresponding product measurement data 122 includes inspection time (inspection of setup time of work order), machine numbering and work order numbering of the transient detector 92A. The machine rotation speed 22 refers to the operation speed of the machine motor, the machine status 23 includes status types such as shutdown, standby, normal operation and manual adjustment, and the number of stamping per second 24 is the number of stamping per second by the machine. The specification measurement value 27 is the maximum value and minimum value of each specification measured in the sampling inspection results during product sampling.

By pairing data with the same dataset numbering (21 and 25), the input dataset 20 of machine status data 121 and product measurement data 122 is formed, which is then used as training data for the network model. In the present embodiment, from the machine status data 121 and the product measurement data 122 with the same dataset numbering (21 and 25), default time differences between the inspection time of the transient detector 92A and the production time of the stamping machine 91A may be set to select the real-time machine status data 121 with the smallest difference from the default time difference to conduct the matching for forming the input dataset 20. For example, if the difference between stamping production and inspection time is approximately one hour, the default time difference may be set to one hour. The real-time machine status data 121 one hour before the detection time point is selected to pair with the product specification measurement data 122 to form the input dataset 20.

In another embodiment, samples may be extracted from the training data by further utilizing the bootstrap aggregating method in the manner of sampling with replacement. That is, in addition to the aforementioned paired time point data, multiple periods of real-time machine status data 121 are continuously extracted from a time point with the smallest difference from the default time difference to generate a subset 20A of the input dataset 20 as model training data. The input dataset 20 may be divided into training data and test data according to a predetermined ratio, such as a 7:3 ratio. During training, the training data may be divided again and the training performance may be evaluated in the cross-validation method.

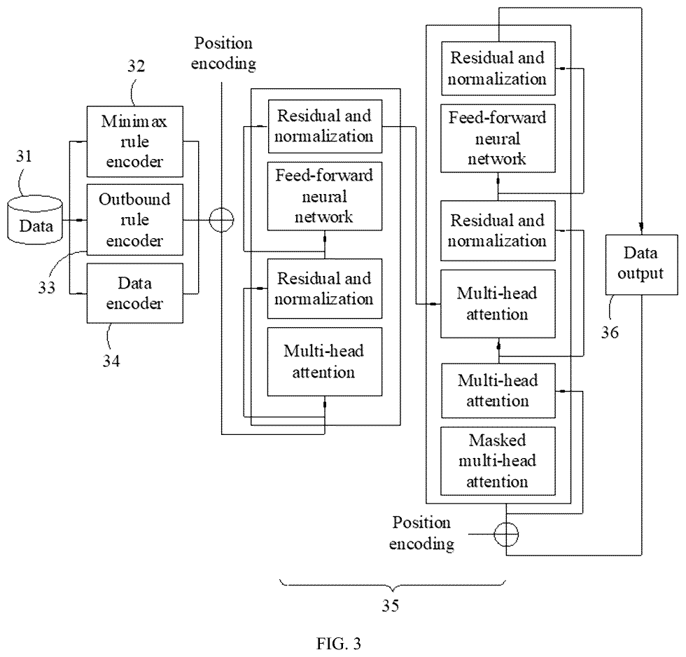

Please refer to FIG. 3, which is a systematic architectural diagram of the quality prediction model according to an embodiment of the present disclosure. As shown in the figure, after obtaining the input dataset 31, the quality prediction module 132 builds a hybrid model framework using a plurality of algorithms 123. The hybrid model framework includes a rule encoder. The rule encoder includes a minimax rule encoder 32, an outbound rule encoder 33 and a data encoder 34. In combination with the three encoders, characteristic values of hidden layers in neural networks are extracted respectively. The data encoder 34 refers to predicting product specifications, whose objective function is the discrepancy between predicted product rules and actual measurement specifications. This discrepancy is expressed as the residual e3 of the loss function. In the present embodiment, the loss function of the data encoder 34 may be expressed as the mean square value of the difference between the predicted value and the actual value, as shown in Equation (1).

$${L}_{Task} = M S E ( y , \hat{y} ) \qquad ( 1 )$$

Specifically, y is actual value and ŷ is predicted value.

In the present embodiment, in addition to the residual between the actual value and the predicted value, the logical control rule of the minimax rule and the outbound rule is also added to improve the accuracy of the overall prediction. In the minimax rule encoder 32, whether the maximum value of predicted specification is greater than the minimum value of the predicted specification is determined every time, and if not (the maximum predicted specification is less than the minimum predicted specification), the minimax rule encoder 32 generates the first loss value e1 through the minimax value loss function. The minimax value loss function of the minimax rule encoder 32 may be expressed by Equation (2).

$${L}_{minmax rule} = {\sum }_{i = n , j = 0}^{2 n - 1 , n - 1} floor ( \hat{y} [ : , i ] \div \hat{y} [ : , j ] ) \qquad ( 2 )$$

Specifically, i is the min value of the predicted specification, j is the max value of the predicted specification, and n is the number of predicted specifications. The predicted minimum value is divided by the maximum value, whose result is then unconditionally rounded up. If the predicted minimum value is greater than the maximum value, 1 is sent back, and finally the results of all specifications are added to become the first loss value e1.

In the outbound rule encoder 33, whether the actual value and the predicted value of each specification fall within the minimax standard is determined, and if not (the actual value of the specification meets the standard, but the predicted value of the specification does not; the actual value of the specification does not meet the standard, but the predicted value of the specification does), the second loss value e2 is generated through an outbound rule loss function. The outbound rule loss function of the outbound rule encoder 33 may be expressed by Equation (3).

$${L}_{outbound rule} = {\sum }_{i = 0}^{2 n - 1} \vert floor ( y [ : , i ] \div std ( i ) ) - floor ( \hat{y} [ : , i ] \div std ( i ) ) \vert \qquad ( 3 )$$

Specifically, n is the predicted specification number, std is the minimax range of the specification. First, the actual value and the predicted value are divided by the boundary of the specification, whose result is then unconditionally rounded up. The values greater than the specification range are converted to 1, and the values smaller than the specification range are converted to 0. Finally, the absolute value is obtained by subtracting the two converted values representing the actual value and the predicted value. If the two values are the same, the second loss value e2 is 0; on the contrary, if the two values are different, the second loss value e2 is 1.

Finally, the weights are adjusted during model training by combining the three loss functions. The first loss value may include a first weight, the second loss value may include a second weight, and the residual e between the predicted value and the true value is calculated, which is represented by Equation (4).

$${L}_{Total} = α ⋆ {L}_{minmax rule} + β * {L}_{outbound rule} + ( 1 - α - β ) * {L}_{Task} ( α ∈ [ 0 , 1 ] , β ∈ [ 0 , 1 ] ∧ ( α + β ) \leq 1. ) \qquad ( 4 )$$

α is the first weight, and β is the second weight. The first weight may range from 0 to 0.4, and the second weight may range from 0 to 0.6. In other embodiments, the first weight may be 0.1 and the second weight may be 0.1.

The aforementioned data is inputted into the transformer model 35, and the transformer model 35 includes an encoder and a decoder. After the data is positionally encoded, the association between words is calculated through self-attention. That is, each mark in the context is generated and embedded, which includes information about the mark itself and information about other related marks weighted by attention weights. Multi-head attention calculates multiple attention weights among all marks, which enters the feed-forward network to perform learning using ReLU as the excitation function after residual and normalization. After entering the decoder, because the decoder makes predictions sequentially, masked multi-head attention does not need to calculate the correlation between a word and a subsequent word (future data) when predicting, so a mask is used to cover up the information behind the location. Multi-head attention calculates the correlation between the output and the input, which then enters the feed-forward network to perform learning using ReLU as the excitation function. Residual and normalization calculations can be included among these operations, and finally, the final output data 36 is outputted. The maximum and minimum predicted values of the model output are determined for size specification. If the maximum predicted value or minimum predicted value of a size code exceeds the upper and lower bounds of the size specification, it is considered a defective product and marked as 0; in contrast, if all meet the specifications, it is considered a non-defective product and marked as 1. The same method is also used for the real value to determine whether it meets the specifications, which is marked as the basis for the calculation of the accuracy rate. In the present embodiment, the self-attention converter model is used as the real-time quality prediction model of the quality prediction module 132. However, the present disclosure is not limited thereto. In other embodiments, other deep learning network frameworks may also be selected as the real-time quality prediction model of the quality prediction module 132, such as a bidirectional long short-term memory network model.

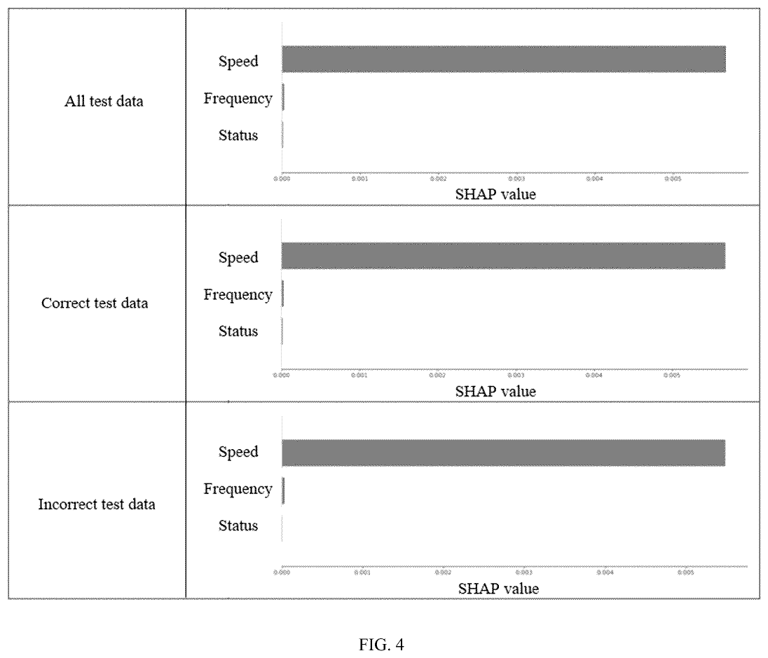

Please refer to FIG. 4, which is a schematic diagram of the network explanation module according to an embodiment of the present disclosure. After the input dataset is calculated by the real-time quality prediction model to output data, the network explanation module 133 may perform an approximate calculation of the backpropagation of the quality prediction model through explainable AI technology, further measuring the contribution level of each input variable to the prediction result. In the present embodiment, the SHAP (SHapley Additive explanations) method is used to estimate the Shapley value, and a feature input vector x is considered, which is defined as x=[x₁, x₂, . . . , x_{D}], where D is the characteristic dimension. The Shapley value may be used to calculate the relevance of a particular feature x_{d} by observing the change in the predicted value outputted by the neural network when the feature is present and absent. To avoid retraining the neural network for each combination of present and absent features, absent features are replaced with approximate expected values. The value is 1 provided being the value of the original sample, and the value is 0 provided being the value of the random sample. The model is calculated as shown in Equation (5).

$$g ( {x}^{( i )} ) = {ϕ}_{0} + {\sum }_{d = 1}^{D} {ϕ}_{d} {x}_{d}^{( i )} \qquad ( 5 )$$

Wherein ϕ₀ is the mean of the predicted value, ϕ_{d} is the Shapeley value, x_{d}∈{0, 1}, and x⁽ⁱ⁾ is a certain sample.

By providing a small amount of training data as a reference value for the sample distribution, the Shapley value of each input in the neural network model is quickly and approximately calculated, the absolute value of which is then taken (without considering positive and negative contribution level) and remodeled in terms of individual variables as units, to understand the variables in the machine status data 121, for example, contribution level of speed (machine rotation speed), frequency (stamping per second), and machine status in the overall input data to the prediction of product measurement data. As shown in FIG. 4, among the aforementioned variables, speed accounts for the highest predicted contribution level of the entire model, while frequency and status significantly have lower contribution levels. If the contribution levels of different periods are considered, the data of the initial and last periods has the highest contribution level to the prediction.

After obtaining the Shapley value of the variables in the machine status data to the product measurement data, the optimal machine prediction module 134 calculates a capability of accuracy value (CK value) of the machine status data corresponding to the product measurement data and selects a plurality of machine status data whose capability of accuracy value (CK value) is closest to a standard center value as optimal machine data. When the real-time quality prediction model predicts that defective products may be generated in the future, field operators may make adjustments to the machine accordingly. The capability of accuracy value (CK value) is calculated as shown in Equation (6).

$$C K = [ detail - ( U + L ) / 2 ] / [ ( U - L ) / 2 ] \qquad ( 6 )$$

Wherein, detail is the predicted maximum value and predicted minimum value of the specification, U is the upper tolerance specification bound, and L is the lower tolerance specification bound. The M pieces of data with the capability of accuracy value closest to 0 are taken as the benchmark for the optimal machine data combination (the lower the optimal machine evaluation value, the closer it is to the center value of the specification), meaning that the M pieces of machine data indicate the process status that may stably manufacture non-defective products.

The capability of accuracy value may include the maximum specification evaluation value (Max CK) and the minimum specification evaluation value (Min CK) of the predicted product specifications; if the maximum specification evaluation value is greater than an upper tolerance bound, the predicted product specification is adjusted based on the maximum specification evaluation value, and if the minimum specification evaluation value is less than a lower tolerance bound, the predicted product specification is adjusted based on the minimum specification evaluation value, so that the prediction results may be closer to the standard center.

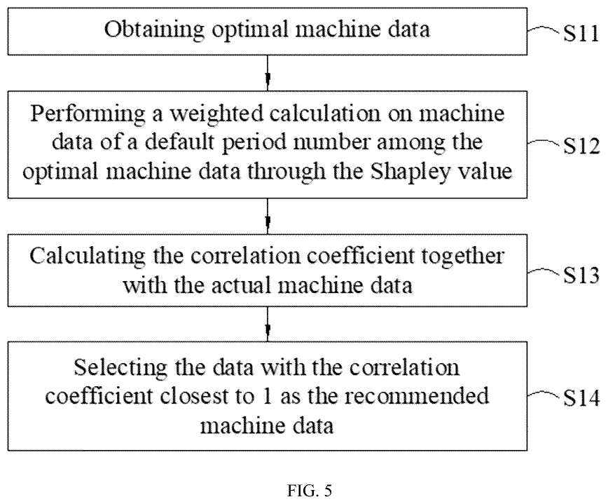

Please refer to FIG. 5, which is an operational flowchart of a recommended machine data module according to an embodiment of the present disclosure. The quality cause analysis model 131 may further include a recommended machine data module, as shown in the figure, which includes the following steps (S11-S14):

Step S11: obtaining optimal machine data. The capability of accuracy value is calculated respectively from the predicted maximum value and predicted minimum value of N specifications, which is then taken for the absolute value. For specifications predicted to be abnormal, the maximum specification evaluation value and the minimum specification evaluation value are averaged, and the M pieces of data closest to 0 are used as the benchmark.

Step S12: performing a weighted calculation on machine data of a default period number among the optimal machine data through the Shapley value. The current machine data (actual values) and M pieces of data (recommended values) for the former P periods of machine data are obtained, and the weighted calculation is performed together with the Shapley value respectively. The current period Shapley value is calculated by adding the absolute values of the maximum specification evaluation value and the minimum specification evaluation value.

Step S13: calculating the correlation coefficient together with the actual machine data. Each piece of correlation coefficient of the weighted machine data of the former P periods between the actual value and the recommended value is calculated respectively.

Step S14: selecting the data with the correlation coefficient closest to 1 as the recommended machine data. The data with the correlation coefficient closest to 1 is selected, which means that the two sequences are closest, and the latter S period of the data is used as the optimal machine data for prediction. The number or period of the aforementioned N, M, P and S may be adjusted appropriately according to the type of product or the type of machine.

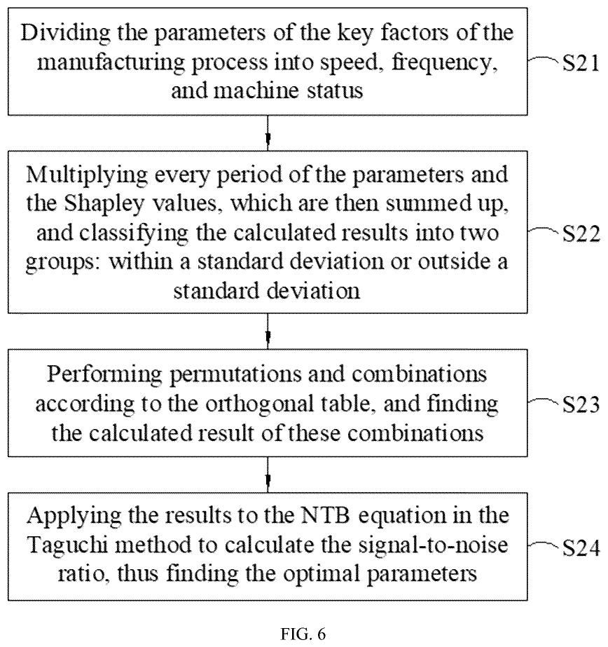

Please refer to FIG. 6, which is an operational flowchart of the Taguchi method according to an embodiment of the present disclosure. The quality cause analysis model 131 further includes a Taguchi method analysis module, which calculates a system parameter in the real-time quality prediction network and obtains the optimal parameter combination through system parameter optimization. As shown in the figure, the following steps (S21-S24) are as follows:

Step S21: dividing the parameters of the key factors of the manufacturing process into speed, frequency and machine status. Machine status data is mainly considered for the key process factors, including speed (machine rotation speed), frequency (stamping per second) and machine status.

Step S22: multiplying every period of the parameters and the Shapley values, which are then summed up, and classifying the calculated results into two groups: within a standard deviation or outside a standard deviation. The orthogonal table in Table 2 is shown below as an example. The parameter combinations in the orthogonal table are divided into within or outside X standard deviations, shown as 1 and 2.

TABLE 2

| | Speed | Frequency | Status | y1 | y2 | y̅ | S² | SN |
|---|---|---|---|---|---|---|---|---|
| 1 | 1 | 1 | 1 | 8 | 6 | 7 | 3 | 5.63 |
| 2 | 1 | 2 | 2 | 3 | 2 | 2.5 | 0.75 | 10.4 |
| 3 | 2 | 1 | 2 | 3 | 4 | 3.5 | 0.75 | 13.3 |
| 4 | 2 | 2 | 1 | 7 | 5 | 6 | 3 | 6.02 |

Step S23: performing permutations and combinations according to the orthogonal table, and finding the calculated result (y values) of these combinations. The y values are the specification values predicted by the parameter combinations, and y̅ is the average of the two y values (y1, y2).

Step S24: applying the results to the NTB equation in the Taguchi method to calculate the signal-to-noise ratio, thus finding the optimal parameters. The NTB equation is shown as Equation (7) and Equation (8).

$${S}^{2} = {( y 1 - \overline{y} )}^{2} + {( y 2 - \overline{y} )}^{2} \qquad ( 7 )$$

$$SN = 10 * {log}_{10} ( {y}^{2} / {s}^{2} ) \qquad ( 8 )$$

The Taguchi method is a method of optimizing the design of system parameters through experiments. Different combinations of parameter levels may result in different specifications of the final product. Through parameter design, an optimal parameter level combination may be found to minimize all kinds of variations, making the product least sensitive to the sources of variation. Key factors that determine the manufacturing process are obtained using the NTB equation in the Taguchi method. When yield problems occur in the future, priority may be given to the key factors.

The above description is merely illustrative rather than restrictive. Any equivalent modifications or alterations without departing from the spirit and scope of the present disclosure are intended to be included in the following claims.

What is claimed is:

1. A quality cause analysis system, comprising:
an input device, connected to a production machine and a measuring machine, and receiving machine status data of the production machine and product measurement data of the measuring machine;
a storage device, connected to the input device, and the storage device storing the machine status data, the product measurement data and a plurality of algorithms;
a processing device, connected to the storage device, the processing device executing a plurality of control commands to access the storage device to establish a quality cause analysis model, and the quality cause analysis model comprising following modules:
a quality prediction module, inputting the machine status data and the product measurement data into a real-time quality prediction network, and predicting whether the product measurement data meets quality inspection regulations by the machine status data;
a network explanation module, performing an approximate calculation of the real-time quality prediction network by an explainable AI algorithm to measure a Shapley value of a plurality of state variables in the machine status data to the product measurement data; and
an optimal machine prediction module, calculating a capability of accuracy value of the machine status data corresponding to the product measurement data, and selecting a plurality of machine status data whose capability of accuracy value is closest to a standard center value as optimal machine data; and
an output device, connected to the processing device and the storage device, and outputting the Shapley value of the plurality of state variables and the optimal machine data for an analysis of quality causes of produced products.

2. The quality cause analysis system according to claim 1, wherein the production machine comprises a stamping machine, and the measuring machine comprises a transient detector.

3. The quality cause analysis system according to claim 2, wherein the real-time machine status data comprises dataset numbering, machine rotation speed, machine status and stamping per second.

4. The quality cause analysis system according to claim 2, wherein the product specification measurement data comprises dataset numbering, inspection time and specification measurement value.

5. The quality cause analysis system according to claim 1, wherein the capability of accuracy value comprises a maximum specification evaluation value and a minimum specification evaluation value of a predicted product specification; if the maximum specification evaluation value is greater than an upper tolerance bound, the predicted product specification is adjusted based on the maximum specification evaluation value, and if the minimum specification evaluation value is less than a lower tolerance bound, the predicted product specification is adjusted based on the minimum specification evaluation value.

6. The quality cause analysis system according to claim 5, wherein the quality cause analysis model further comprises a recommended machine data module, which performs a weighted calculation on machine data of a default period number among the optimal machine data through the Shapley value, calculates correlation coefficient together with actual machine data respectively, and selects data with the correlation coefficient closest to 1 as recommended machine data.

7. The quality cause analysis system according to claim 6, wherein the weighted calculation is to add a current period Shapley value to the machine data, and the current period Shapley value is an absolute value of the maximum specification evaluation value and an absolute value of the minimum specification evaluation value.

8. The quality cause analysis system according to claim 1, wherein the quality cause analysis model further comprises a Taguchi method analysis module, which calculates a system parameter in the real-time quality prediction network and obtains optimal parameter combination through system parameter optimization.

9. The quality cause analysis system according to claim 8, wherein the system parameter comprises a signal-to-noise ratio.

10. The quality cause analysis system according to claim 9, wherein the signal-to-noise ratio is calculated by multiplying every period of machine data and every period of Shapley values and summing them up, a result of which is divided into two groups that are within a standard deviation or outside the standard deviation, as well as calculating a specification value of parameter combination through orthogonal table permutations, which is then substituted to an Nominal-the-best method to obtain the signal-to-noise ratio.
